(19) United States
(12) Patent Application Publication
(10) Pub. No.: US 2026/0166701 A1
(43) Pub. Date: Jun. 18, 2026

(54) POWER TOOL WITH AN ELECTRO-MECHANICAL SPEED SELECT MECHANISM

(71) Applicant: MILWAUKEE ELECTRIC TOOL CORPORATION, Brookfield, WI (US)

(72) Inventors: Kirtan Jha, Brookfield, WI (US); Brian T. Callen, Wauwatosa, WI (US); Daniel J. Tomcheck, Denmark, WI (US); Jonathan Fritsch, Brookfield, WI (US)

(21) Appl. No.: 19/421,214

(22) Filed: Dec. 16, 2025

Related U.S. Application Data
(60) Provisional application No. 63/734,663, filed on Dec. 16, 2024.

(51) Int. Cl. B25D 16/00

(52) U.S. Cl. CPC B25D 16/006; B25D 16/003; B25D 2216/0084; B25D 2250/095; B25D 2250/165; B25D 2250/221; B25D 2250/255

(57) ABSTRACT

A power tool includes a housing and a drive mechanism supported within the housing. The drive mechanism has a motor and a transmission configured to receive torque from the motor. The power tool further includes an output drive operably coupled to the drive mechanism to provide torque to a workpiece and an electro-mechanical speed select mechanism. The electro-mechanical speed select mechanism has a switch operably coupled to the transmission to adjust an operating gear ratio when moving between a first switch position and second switch position, and a collar movably coupled to the housing to electronically adjust an operating speed of the motor. The collar is movable between a first position corresponding to a first electronic speed setting and a second position corresponding to a second electronic speed setting different than the first electronic speed setting.

### CROSS-REFERENCE TO RELATED APPLICATIONS

This application claims priority to U.S. Provisional Patent Application No. 63/734,663, filed Dec. 16, 2024, the entire contents of which are incorporated herein by reference.

### FIELD OF THE INVENTION

The present invention relates to a power tool, and more particularly to rotary power tools such as a drill or a hammer-drill.

### BACKGROUND OF THE INVENTION

Many rotary power tools are designed to operate in multiple modes to accommodate different applications and user preferences. For example, a power tool may be configurable to operate at different speeds or torque outputs depending on the task at hand. Various mechanisms have been employed to allow users to adjust the operating characteristics of power tools. Mechanical transmissions, such as multi-speed planetary gear systems, can be used to provide different gear ratios that affect the speed and torque output of the tool. Electronic controls can also be used to adjust motor speed by varying the power delivered to the motor. Some power tools incorporate clutch mechanisms that limit the torque transmitted to the output drive, which can help prevent damage to fasteners or workpieces and reduce the risk of injury to the operator.

In some rotary power tools, particularly hammer-drills, additional functionality is provided through mechanisms that impart axial impacts to the output drive in addition to rotational motion. This hammering action can be useful for drilling into hard materials such as concrete or masonry.

The user interfaces for selecting between different operating modes and adjusting operating parameters vary among different power tool designs. Some tools employ separate switches, dials, or collars for different functions. The arrangement and operation of these controls can affect the ease of use and versatility of the power tool.

### SUMMARY OF THE INVENTION

In some aspects, the techniques described herein relate to a power tool including: a housing; a drive mechanism supported within the housing, the drive mechanism having a motor and a transmission configured to receive torque from the motor; an output drive operably coupled to the drive mechanism to provide torque to a workpiece; and an electro-mechanical speed select mechanism including a switch operably coupled to the transmission to adjust an operating gear ratio when moving between a first switch position and second switch position, and a collar movably coupled to the housing to electronically adjust an operating speed of the motor, the collar movable between a first position corresponding to a first electronic speed setting and a second position corresponding to a second electronic speed setting different than the first electronic speed setting.

In some aspects, the techniques described herein relate to a power tool including: a housing; a drive mechanism supported within the housing, the drive mechanism having a motor and a transmission configured to receive torque from the motor; an output drive operably coupled to the drive mechanism to provide torque to a workpiece; and an electro-mechanical speed select mechanism including a first actuator operably coupled to the transmission and operable to adjust an operating gear ratio of the transmission by moving a ring gear of the transmission, and a second actuator operable to electronically adjust a maximum operating speed of the motor.

In some aspects, the techniques described herein relate to a power tool including: a housing; a drive mechanism supported within the housing, the drive mechanism having a motor and a transmission configured to receive torque from the motor; an output drive operably coupled to the drive mechanism to provide torque to a workpiece, the output drive configured to be driven by the motor about a first axis; a clutch mechanism operably coupled between the drive mechanism and the output drive; and an electro-mechanical speed select mechanism including a switch operably coupled to the transmission to adjust an operating gear ratio, and a collar movably coupled to the housing between a first position corresponding to a first electronic speed setting, a second position corresponding to a second electronic speed setting different than the first electronic speed setting, and a third position corresponding to a clutch mode in which an output torque of the output drive is limited by the clutch mechanism.

Other features and aspects of the present disclosure will become apparent upon consideration of the following detailed description and accompanying drawings.

### BRIEF DESCRIPTION OF DRAWINGS

FIG. 1 is a perspective view of a rotary power tool according to an embodiment of the present invention, and auxiliary handle removably coupled to the rotary power tool.

FIG. 2 is a perspective view of the rotary power tool of FIG. 1.

FIG. 3 is cross-sectional view of the rotary power tool of FIG. 1.

FIG. 4 is an enlarged view of a dial assembly.

FIG. 5A is a perspective view of a drive mechanism of the rotary power tool of FIG. 1.

FIG. 5B is another perspective view of the drive mechanism of FIG. 5A.

FIG. 6A is a front perspective view of a collar printed circuit board with a wiper spring in contact with electrical pads of the collar printed circuit board.

FIG. 6B is a front perspective view of the collar printed circuit board of FIG. 6A.

FIG. 7 is a perspective view of a rotary power tool according to another embodiment of the present invention.

FIG. 8 is a cross-sectional view of the rotary power tool of FIG. 7.

FIG. 9A is an exploded view of a hammer mechanism.

FIG. 9B is another exploded view of the hammer mechanism of FIG. 9A.

FIG. 10A is a front perspective view of a collar printed circuit board with a wiper spring in contact with electrical pads of the collar printed circuit board.

FIG. 10B is a front perspective view of the collar printed circuit board of FIG. 10A.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

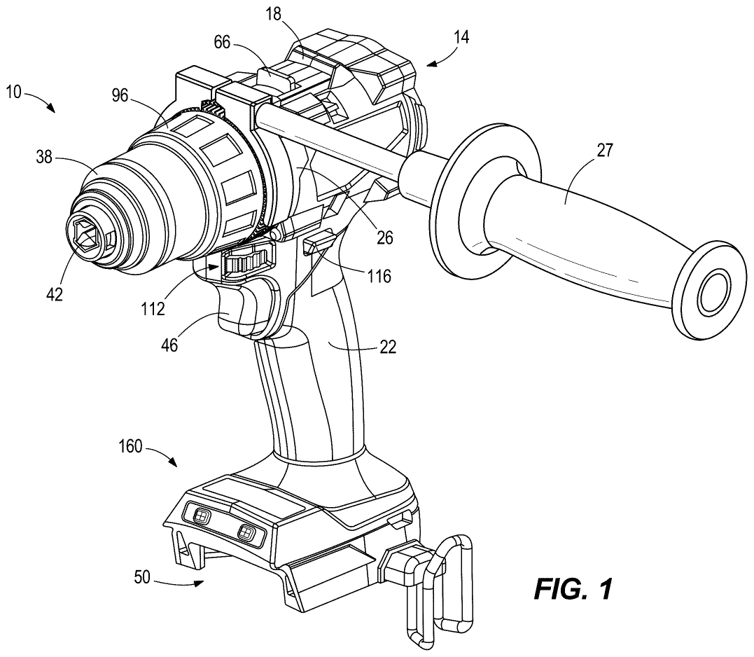

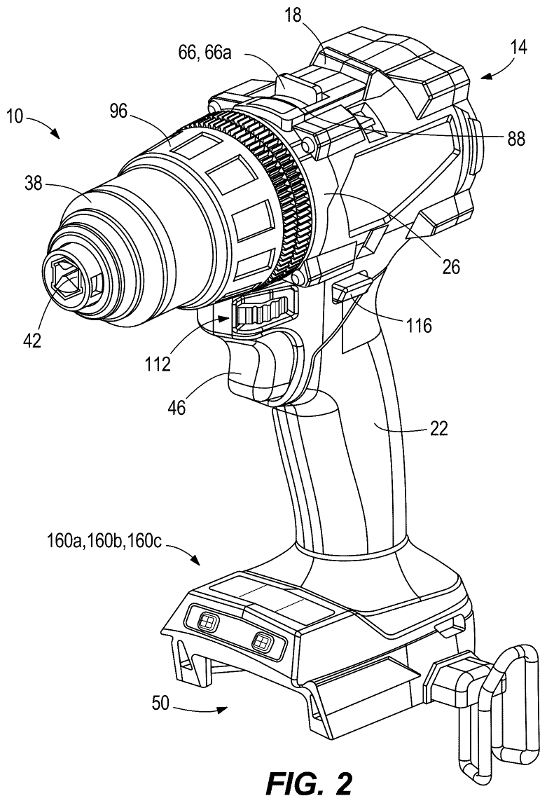

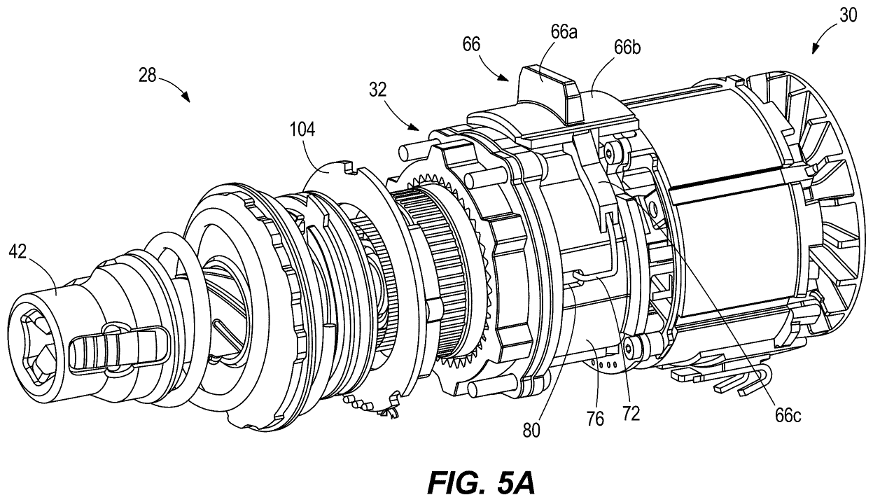

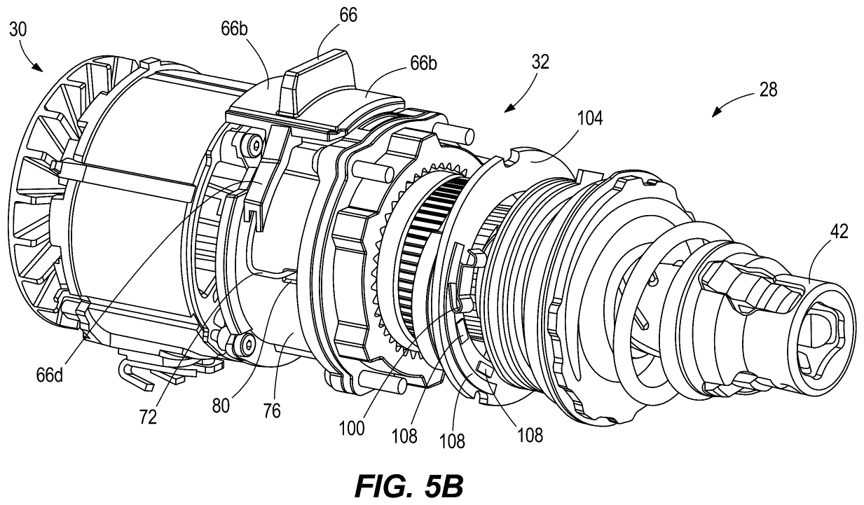

FIGS. 1 and 2 illustrate a rotary power tool 10 in the form of a drill. The power tool 10 includes a housing 14 having a motor housing portion 18, a handle portion 22, and a front housing portion 26. The handle portion 22 extends from the motor housing portion 18 such that the power tool 10 forms a pistol grip configuration. In the illustrated embodiment, the power tool 10 also includes an auxiliary handle 27 that is removably coupled to the front housing portion 26. The front housing portion 26 is coupled to a front side of the motor housing portion 18. The power tool 10 further includes a drive mechanism 28 (FIGS. 5A and 5B) disposed within the housing 14. The drive mechanism 28 has an electric motor 30 (e.g., a brushless DC electric motor) supported within the motor housing portion 18 and a transmission 32 supported at least partially within the front housing portion 26. The electric motor 30 has an output shaft 34 rotatably coupled to the transmission 32 to thereby transmit a torque from the electric motor 30 to the transmission 32. In the illustrated embodiment, the transmission 32 is a multi-speed planetary transmission, which is shiftable to provide the power tool 10 with different output speeds.

With continued reference to FIGS. 1 and 2, the power tool 10 further includes a chuck 38 having an output drive 42 operably coupled to the drive mechanism 28 such that the electric motor 30 may drive the output drive 42 about a first axis or longitudinal axis A1. The longitudinal axis A1 is coaxial with the output shaft 34 of the electric motor 30. The output drive 42 is configured to support a working tool bit (e.g., drill bit, screwdriver bit, or the like; not shown). Torque is transmitted from the electric motor 30 through the drive mechanism 28 and to the output drive 42 to be imparted on a workpiece. The electric motor 30 is operated via a trigger 46 located on the handle portion 22. A battery receptacle 50 is formed on an end of the handle portion 22 and configured to receive a battery pack (not shown) to provide power to the electric motor 30.

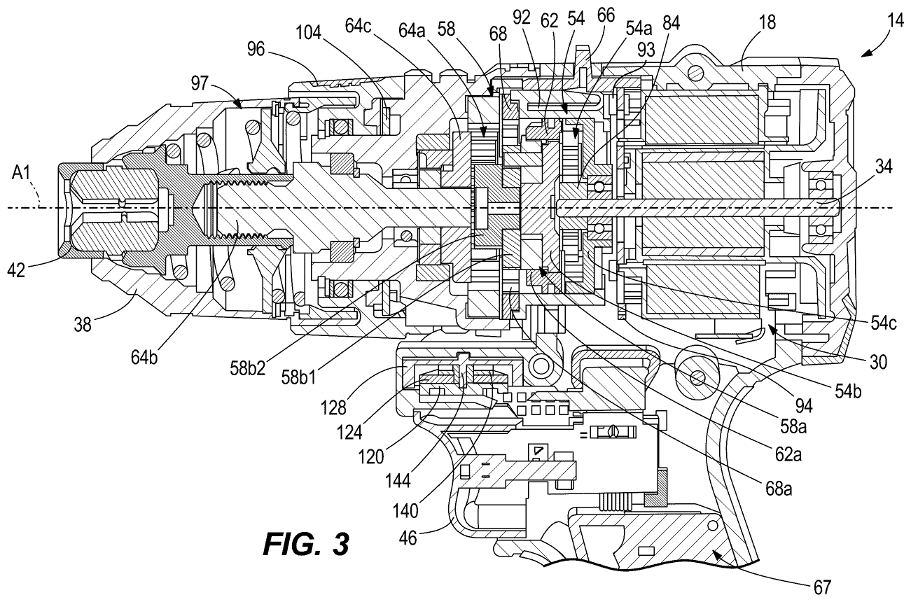

With reference to FIGS. 3, 5A and 5B, the transmission 32 includes a first gearset 54, a second gearset 58, a movable ring gear 62, a first actuator or speed selector switch 66, and a lock ring 68. The speed selector switch 66 is movably coupled to the housing 14. Also, the speed selector switch 66 is coupled to the movable ring gear 62 via a wire 72 to shift the movable ring gear 62 such that the transmission 32 is capable of providing a first operating mode (e.g., a low speed and high torque mode, which may be referred to as a mechanical low speed mode) and a second operating mode (e.g., a high speed low torque mode, which may be referred to as a mechanical high speed mode). The transmission 32 further includes a transmission gearcase 76 having a slot 80 through which the wire 72 extends.

The first gearset 54 includes a plurality of first planet gears 54a, first carrier gear 54b, and a first ring gear 54c. The first planet gears 54a engage the first ring gear 54c and are configured to receive torque from the output shaft 34 via a pinion 84 to drive the first carrier gear 54b. The second gearset 58 includes a plurality of second planet gears 58a, a first coupler 58b1 and a sun gear 58b2 coupled to form a second carrier gear, and the movable ring gear 62 which functions as a second ring gear. The movable ring gear 62 includes a plurality of inner teeth 62a and a plurality of outer teeth (not shown). The inner teeth 62a are dimensioned to selectively engage one or both of the second planet gears 58a and the first carrier gear 54b. The outer teeth of the movable ring gear 62 are dimensioned to selectively engage inner teeth 68a of the lock ring 68. The second carrier gear is coupled to third planet gears 64a and a drive shaft 64b via a second coupler 64c. The drive shaft 64b is coupled to the output drive 42.

The speed selector switch 66 is capable of moving the movable ring gear 62 between a first (e.g., forward, to the left as viewed in FIG. 3) switch position corresponding with the mechanical low speed mode of the power tool 10, whereby both the first gearset 54 and the second gearset 58 provide a speed reduction and torque increase from the electric motor 30, and a second (e.g., rearward, to the right as viewed in FIG. 3) switch position corresponding with the mechanical high speed mode of the power tool 10, whereby the first gearset 54 provides a speed reduction and torque increase from the electric motor 30 and the movable ring gear 62 is free to rotate, effectively disabling the second gearset 58. As such, the speed selector switch 66 is operable by a user to mechanically change a gear ratio at which the power tool 10 operates.

In more detail, in the first switch position (not shown), the inner teeth 62a of the movable ring gear 62 engage the second planet gears 58a and the outer teeth of the movable ring gear 62 engage inner teeth 68a of the lock ring 68. The movable ring gear 62 is inhibited for rotation about the axis A1 by the lock ring 68. When the movable ring gear 62 is in its first switch position, a first torque transmission path passes torque from the electric motor 30 to the output drive 42. The first torque path passes from the output shaft 34 sequentially through the pinion 84, the first stage planet gears 54a, the first carrier gear 54b, the second stage planet gears 58a, the second carrier gear 58b1 , 58b2 , the third stage planet gears 64a, the second coupler 64c, and the drive shaft 64b to the output drive 42. In this arrangement, both the first gearset 54 and the second gearset 58 contribute to an adjustment of speed and torque applied to the output drive 42 from the electric motor 30.

In the second switch position (FIG. 3), the inner teeth 62a of the movable ring gear 62 engage both the second planet gears 58a and the first carrier gear 54b. The first carrier gear 54b, the movable ring gear 62, and the second planet gears 58a are locked for co-rotation (e.g., rotate as a unit). The outer teeth of the movable ring gear 62 are axially separated from the lock ring 68, and the movable ring gear 62 is allowed to rotate. Accordingly, in the second switch position, a second torque transmission path passes from the output shaft 34 sequentially through the pinion 84, the first stage planet gears 54a, the unit including (A) the first carrier gear 54b, (B) the movable ring gear 62, (C) the second stage planet gears 58a, and (D) the second carrier gear 58b1 , 58b2 , the third planet gears 64a, the second coupler 64c, and the drive shaft 64b to the output drive 42. In this arrangement, only the first gearset 54 contributes to an adjustment of speed and torque applied to the output shaft 34 from the electric motor 30.

In the illustrated embodiment, a gripping actuator 66a of the speed selector switch 66 protrudes from a window 88 (FIG. 2) defined within the housing 14. As such, the speed selector switch 66 is actuatable by the user from the exterior of the housing 14, and the speed selector switch 66 is capable of actuating components (e.g., the movable ring gear 62) within the transmission gearcase 76. In the illustrated embodiment, a detent spring 92 (FIG. 3) is provided between the transmission gearcase 76 and the speed selector switch 66 to provide a biasing force against the speed selector switch 66. As such, the detent spring 92 is configured to lock the speed selector switch 66 into the first switch position or the second switch position. In other embodiments, a ball detent mechanism is provided to lock the speed selector switch 66 in the first switch position or the second switch position.

Referring to FIG. 5A, the speed selector switch 66 further includes an arcuate body 66b, a first support 66c, and a second support 66d. The gripping actuator 66a extends from the body 66b opposite the first and second supports 66c, 66d. The first and second supports 66c, 66d are coupled to the wire 72 and extend along a majority of a length of the wire 72 in the illustrated embodiment, which may support the wire 72 and provide stiffness.

Referring again to FIG. 3, the power tool 10 includes a position detecting mechanism disposed within the housing 14. The position detecting mechanism includes a sensor 93 (e.g., a Hall effect sensor) disposed on a front side of a motor printed circuit board (PCB) 94. In some embodiments, the motor PCB 94 also includes a plurality of Hall effect sensors on a rear side of the motor PCB 94, configured to detect the rotation and position of permanent magnets carried by a rotor of the motor 30. The sensor 93 is configured to detect movement of the speed selector switch 66 (e.g., by sensing a magnet (not shown) coupled to the speed selector switch 66) as the speed selector switch 66 moves between the first switch position and the second switch position. As such, the sensor 93 detects a position of the speed selector switch 66 such that an electronic controller 67 (FIG. 3) of the power tool 10 is able to determine whether the speed selector switch 66 is in the first switch position or the second switch position.

The electronic controller 67 (or simply “controller”) in the illustrated embodiment includes a PCBA, which may be operatively coupled to a switching array that regulates power delivery from a battery pack to the motor 30. The controller 67 may include a processor configured to execute machine-readable instructions stored in a non-transitory memory. These instructions may enable the processor to generate control signals for selectively enabling and disabling individual switching elements, such as field-effect transistors (FETs), to achieve precise motor operation. The memory may store operational parameters, calibration data, and firmware updates to support adaptive control strategies. In some embodiments, the controller further includes input/output interfaces for receiving sensor data—such as current, voltage, and temperature—and for transmitting diagnostic information and controlling operation of the power tool 10.

With reference back to FIGS. 1 and 2, the power tool 10 further includes a second actuator or collar 96 rotatably coupled to the front housing portion 26 and configured to electronically control an operating speed (e.g., a maximum operating speed) of the electric motor 30. As such, the collar 96 and the speed selector switch 66 form an electro-mechanical speed select mechanism configured to mechanically change an operating gear ratio of the power tool 10 and electronically adjust a motor operating speed of the power tool 10. The collar 96 is movable between a first position, a second position, and a third position.

The first position may correspond to a first electronic speed setting in which the electric motor 30 is electronically limited to an electronic low speed. The second position may correspond to a second electronic speed setting, different than the first electronic speed setting, in which the electric motor 30 is electronically limited to an electronic high speed greater than the electronic low speed. In some embodiments, the electronic high speed and/or the electronic low speed may be peak motor speeds, and the motor may operate to approach the electronic high speed and/or the electronic low speed at any desired rate (e.g., a ramp up rate) controlled either automatically or via a user input (e.g., through varying displacement of the trigger 46).

The third position may correspond to a clutch mode in which an electronic clutch mechanism 97 is enabled. A leaf spring or detent may be coupled to the collar 96 to provide a retention force to maintain the collar 96 within a selected position and an indication (e.g., a clicking sound, tactile feel, or the like) that the selected position has been reached.

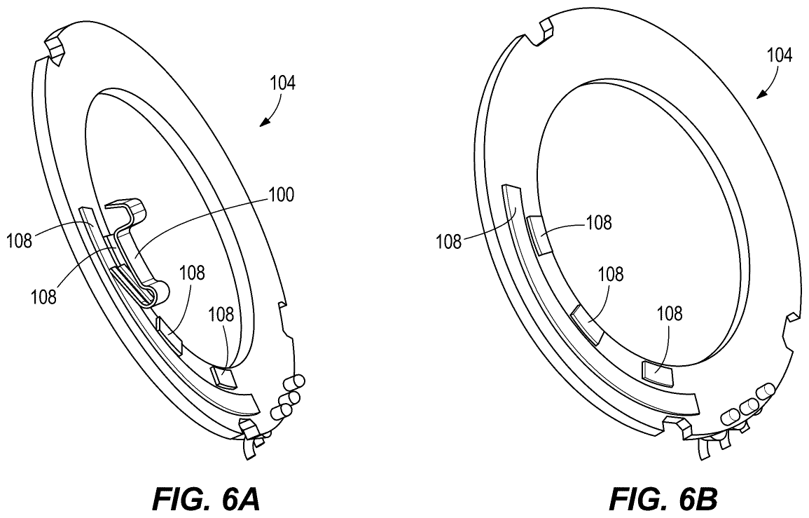

With reference to FIGS. 6A and 6B, the collar 96 is coupled to a wiper spring 100 such that the wiper spring 100 is coupled for rotation with the collar 96. A collar printed circuit board 104 is disposed within the front housing portion 26 such that the wiper spring 100 is in contact with the collar printed circuit board 104. When the collar 96 is rotated, the wiper spring 100 is slidable along a plurality of electrical pads 108 provided on the collar printed circuit board 104 to generate an electrical path that provides a variable resistance (e.g., depending which of the electrical pads 108 is aligned with the wiper spring 100) that can be detected by the controller 67 of the power tool 10. Each electrical pad 108 corresponds to a respective position of the collar 96 to thereby allow the controller 67 to detect which position/mode the collar 96 has selected. In some embodiments, the collar 96 may additionally or alternatively carry one or more magnets, and the collar printed circuit board 104 may include a plurality of Hall effect sensors (e.g., in place of the electrical pads 108) able to detect the position of the magnet(s) and thereby determine which position/mode the collar 96 has selected. In yet other embodiments, the collar 96 and the circuit board 104 may include other suitable combinations of features and sensors to detect the position/mode of the collar 96 and provide that feedback to the controller 67.

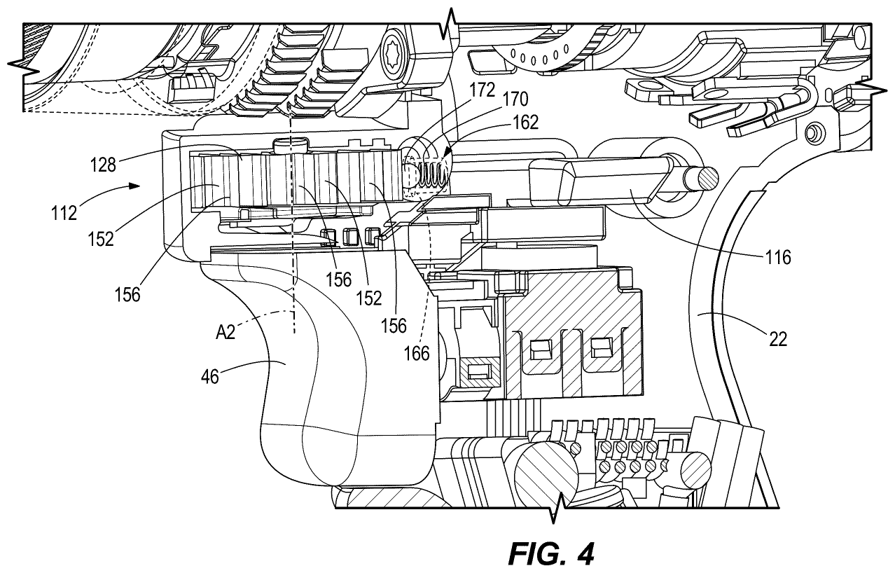

With reference to FIGS. 3 and 4, the illustrated power tool 10 also includes a dial assembly 112 and a multi-position switch 116, which may be referred to as a forward/reverse switch. The dial assembly 112 is positioned partially within and extends beyond the housing 14, and a portion of the dial assembly 112 is rotatable about a second axis or dial axis A2 orthogonal to the longitudinal axis A1. The multi-position switch 116 is also positioned partially within and extends beyond the housing 14. In the illustrated embodiment, the dial assembly 112 is positioned above the trigger 46 and below the collar 96, and the multi-position switch 116 is positioned rearward of the dial assembly 112. The trigger 46, the dial assembly 112, and the multi-position switch 116 may each be positioned to be accessible to and actuatable by a user's forefinger and/or thumb while the user is grasping the handle 22. Movement of the dial assembly 112 and the multi-position switch 116 are configured to alter the operational characteristics of the power tool 10, as described below.

For example, the electronic clutch mechanism 97 of the power tool 10 is configured to receive an electronic torque setting and electronically (e.g., via controller 67 stopping operation of the motor 30) and/or mechanically (e.g., via an adjustable slip condition of the clutch mechanism 97) limit the torque output of the power tool 10 based on the torque setting when the power tool 10 is operated in the clutch mode. The power tool 10 may include one or more sensors (e.g., motor current sensors, torque sensors, or any other suitable sensors) able to detect parameters that can be correlated with a torque output of the power tool 10. The controller 67 is configured to activate the electronic clutch mechanism 97 in response to the detected parameters indicating an output torque that equals or exceeds the selected torque setting. In the illustrated embodiment, the dial assembly 112 provides a torque adjustment interface for the power tool 10.

In use, rotation of one or more components of the dial assembly 112 around the dial axis A2 adjusts the torque setting of the power tool 10. The dial assembly 112 is rotatable between a plurality of discrete rotational positions, in which each rotational position corresponds to a respective torque setting of the power tool 10. In the illustrated embodiment, the dial axis A2 intersects the front housing portion 26 and the trigger 46. The dial assembly 112 is accessible from both lateral sides of the power tool 10. This allows the user to rotate the dial assembly 112 about the dial axis A2 (e.g., using the user's index finger) while grasping the handle portion 22 of the power tool 10 with the same hand, thus facilitating one-handed, ambidextrous operation of the power tool 10. In other embodiments, the dial assembly 112 is accessible from both lateral sides and the front of the power tool 10. The power tool 10 may include a set of indicators (not shown) that illuminate a work surface in some embodiments. The set of indicators may be shadowless lights. The indicators may change color or flash in various patterns that are associated with the torque setting (further described herein). Alternatively, the power tool 10 may include a display (e.g., on the battery receptacle 50 or in any other suitable location) to indicate the torque setting.

As illustrated in FIGS. 3 and 4, the dial assembly 112 includes a case 120, a dial circuit board 124, and a dial 128. The case 120 is fixedly coupled to the housing 14 and is shaped to receive the dial circuit board 124. In some embodiments, the case 120 may be integrally formed on the housing 14. In the illustrated embodiment, the dial 128 does not surround the case 120 and instead the dial 128 is positioned on top of the case 120. In other embodiments, an O-ring may be provided to seals an inner volume of the case 120 from a surrounding environment when the dial 128 is installed.

With continued reference to FIGS. 3 and 4, the dial circuit board 124 has a substantially circular profile and is positioned on the case 120. In other embodiments, the dial circuit board 124 may be square, rectangular, hexagonal, octagonal, or polygonal. The dial circuit board 124 includes a rotary position sensor 140 configured to detect a rotational position of the dial 128 via a pin 144 rotatably coupled to and extending from a central portion of the dial 128. In other embodiments, the dial circuit board 124 includes a non-contact sensor positioned in the center of the dial circuit board 124. The non-contact sensor is a 3-Dimensional (“3D”) digital Hall effect sensor configured to generate a signal representative of the magnetic flux of at least one magnet and is configured to communicate with the controller 67 using a digital protocol, such as the I2C protocol. The dial assembly 112 may include other alternate embodiments of the dial circuit board 124.

In the illustrated embodiment, the dial 128 is substantially gear-shaped and includes a cam (not shown), a plurality of teeth 152, and a plurality of bottom lands 156 positioned between the plurality of teeth 152. In the illustrated embodiment, the plurality of bottom lands 156 includes debossed numerical indicators representative of the currently selected setting (e.g., a torque setting). In other embodiments, the bottom lands 156 may include embossed, printed indicators, or text-based indicators to represent the currently selected torque setting. In further embodiments, the bottom lands 156 may not include any indicators on the dial 128, but instead, the currently selected torque setting could be shown using a display or a plurality of LEDs. The teeth 152 and the bottom lands 156 provide additional leverage to the finger of the user to turn the dial 128 about the dial axis A2. In some embodiments, the dial 128 may instead be cylindrical or polygonal. In use, the bottom lands 156 selectively receive a portion of a spring-loaded detent 162, as described in greater detail below.

Referring to FIG. 4, a spring-loaded detent 162 is positioned within the housing 14 of the power tool 10 in the illustrated embodiment. The spring-loaded detent 162 includes a detent casing 166, a spring 170 positioned within the detent casing 166, and a detent ball 172 positioned partially within the detent casing 166. In use, the spring 170 biases the detent ball 172 outward to engage one of the bottom lands 156 of the dial 128. When the detent ball 172 engages one of the bottom lands 156, the rotational resistance of the dial 128 is increased, and thus the orientation of the dial 128 is maintained. To change the orientation of the dial 128, a torque is applied to the dial 128, which moves the detent ball 172 out of one of the bottom lands 156 and into an adjacent bottom lands 156. The detent ball 172 is only moveable out of one of the bottom lands 156 if the torque is large enough to overcome the downward biasing force of the spring 170. In other embodiments, more than one spring-loaded detent 162 may be used to maintain the position of the dial 128.

In one exemplary use of the power tool 10, the user may move the multi-position switch 116 to select a direction of rotation of the motor 30 of the power tool 10 in any operating mode of the power tool 10. The user may also move the speed selector switch 66 to place the power tool 10 in the mechanical low speed mode or the mechanical high speed mode. The user may then manipulate the collar 96 to provide additional functionality, if desired.

For example, when the collar 96 is in the first position, the user may operate the power tool 10 in the electronic low speed mode. In some embodiments, the controller 67 may only implement the electronic low speed mode and limit the speed of the motor 30 when the speed selector switch 66 is in the second switch position corresponding to the mechanical high speed mode. In other embodiments, the controller 67 may limit the speed of the motor 30 regardless of the position of the speed selector switch 66, or the controller 67 may limit the speed of the motor 30 to different electronic low speeds depending on whether the speed selector switch 66 is in the first position or the second position.

The user may move the collar 96 to the second position to operate the power tool 10 in the electronic high speed mode, in which motor speed is increased relative to the electronic low speed mode. In some embodiments, the controller 67 may only implement the electronic high speed mode when the speed selector switch 66 is in the second switch position corresponding to the mechanical high speed mode. In other embodiments, the controller 67 may implement the electronic high speed mode regardless of the position of the speed selector switch 66, or the controller 67 may limit the speed of the motor 30 to different electronic high speeds depending on whether the speed selector switch 66 is in the first position or the second position.

The user may further move the collar 96 to the third position to operate the power tool 10 in the clutch mode. In some embodiments, the controller 67 may only enable the clutch mode when the power tool 10 is in the mechanical low speed mode (e.g., as indicated by the position of the speed selector switch 66). In other embodiments, the controller 67 may enable the clutch mode in both mechanical speed modes. In the clutch mode, the user may rotate the dial 128 of the dial assembly 112 in a first direction or a second direction around the dial axis A2 to choose a desired torque setting. The rotary position sensor 140 detects rotation of the pin 144 and outputs a signal to the controller 67. The controller 67 then determines a torque setting according to the new position of the pin 144. Then, the user may axially displace the trigger 46 along the longitudinal axis A1 to begin operation of the motor 30. In some embodiments, the amount of axial displacement of the trigger 46 is proportional to the rotational speed of the motor 30. In some embodiments, the dial 128 may be rotated while the trigger 46 is already depressed to adjust the torque setting of the clutch while the motor 30 is in motion. In some embodiments, the user may complete the above steps in any order or may choose to omit one or more steps.

With reference back to FIGS. 1 and 2, the power tool 10 may include one or more operation buttons 160 provided on the battery receptacle 50. The operation button(s) 160 may be pressed by the user to actuate a desired electronic mode, in addition to or in place of the collar 96 in some embodiments. In some embodiments, the operation buttons 160 include a first operation button 160a, a second operation button 160b, and a third operation button 160c located on a top surface of the battery receptacle 50 (FIG. 2). The first operation button 160a is selectable by the user to enter the electronic low speed mode. The second operation button 160b is selectable by the user to enter the electronic high speed mode. The third operation button 160c is selectable by the user to enter the clutch mode. As such, the user may use the plurality of operation buttons 160 or the collar 96 to select a desired electronic mode at which the electric motor 30 is controlled by. In other embodiments, any other number or configuration of buttons 160 may be provided. In some embodiments, the operation buttons 160 may be replaced by or supplemented with a display or indicator to indicate to a user the selected mode.

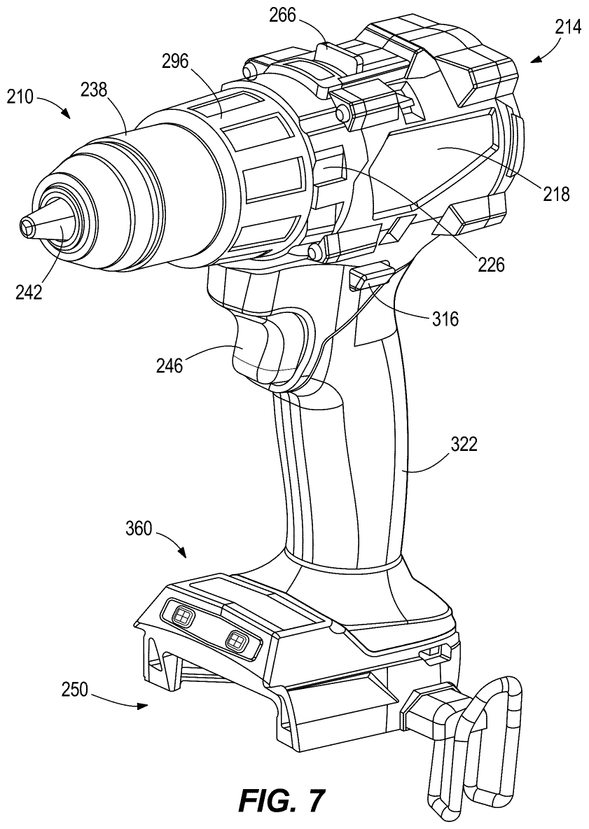

FIGS. 7-10B illustrates another rotary power tool 210. The power tool 210 is similar to the power tool 10 of FIGS. 1-6B; therefore, like structure will be identified by like reference numbers plus “200.” Differences will be discussed herein below. It should be understood that features of the power tool 10 described above may be incorporated into the power tool 210, and vise versa.

With reference to FIG. 7, the power tool 210 is illustrated as a hammer-drill. The power tool 210 includes a drive mechanism 282 having an electric motor 230 supported within the motor housing portion 218, a transmission 232 supported at least partially within the front housing portion 226, and a ratchet mechanism operable to perform a hammer-drilling operation. The ratchet mechanism is disposed within a front housing portion 226 of a housing 214 of the power tool 210. As such, the ratchet mechanism is disposed along a drive shaft 264b of the transmission 232.

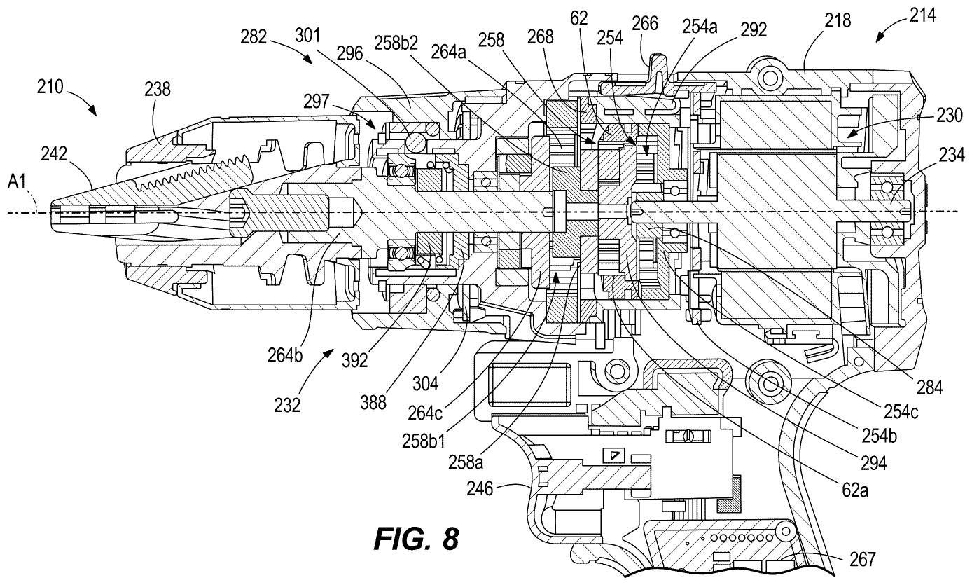

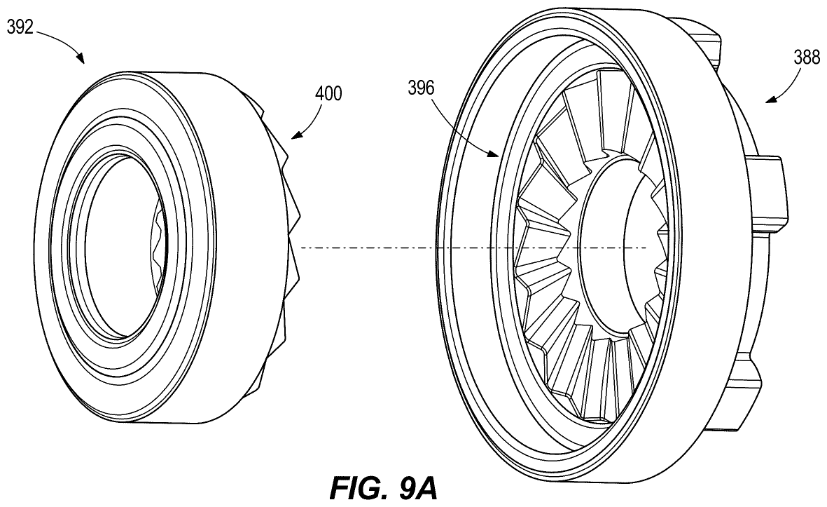

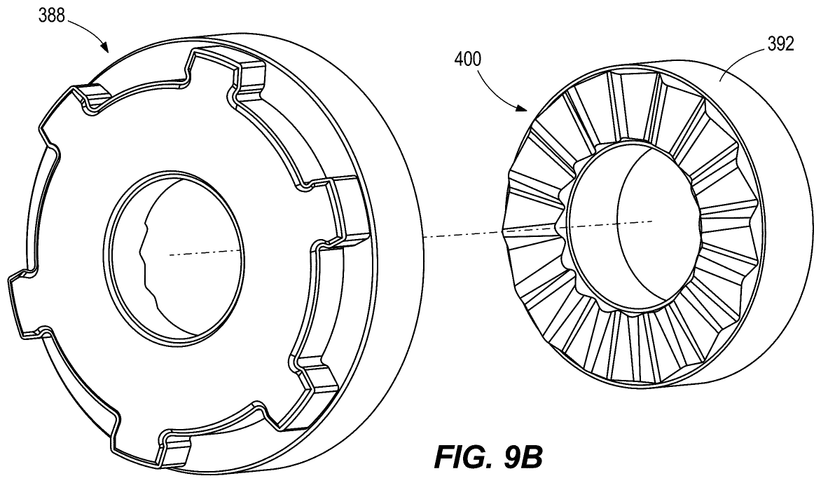

With reference to FIGS. 8, 9A, and 9B, the ratchet mechanism includes a first ratchet or a fixed ratchet 388 secured within the front housing portion 226 and a second ratchet or a rotatable ratchet 392 fixed for rotation with the drive shaft 264b in various ways (e.g., by using an interference fit, welding, etc.). Each of the ratchets 388, 392 include teeth 396, 400 that are engageable and slidable relative to each other in response relative rotation between the ratchets 388, 392. As the teeth 400 of the rotatable ratchet 392 slide over the teeth 396 of the fixed ratchet 388, the contour of the teeth 400 impart reciprocation and axial impacts (i.e., “hammering”) to the drive shaft 264b to thereby provide the hammer-drilling operation when actuated.

With reference to FIG. 8, a collar 296 is rotatably coupled to the front housing portion 226 and configured to electronically control an operating speed of the power tool 10 by electronically limiting the electric motor 230. The illustrated collar 296 is movable between a first position, a second position, a third position, and a plurality of clutch positions, as described below.

The first position may correspond to a first electronic speed setting in which the electric motor 230 is electronically limited to an electronic low speed. The second position may correspond to a second electronic speed setting, different than the first electronic speed setting, in which the electric motor 230 is electronically limited to an electronic high speed greater than the electronic low speed. In some embodiments, the electronic high speed and/or the electronic low speed may be peak motor speeds, and the motor may operate to approach the electronic high speed and/or the electronic low speed at any desired rate (e.g., a ramp up rate) controlled either automatically or via a user input (e.g., through varying displacement of the trigger 246).

The third position may correspond to a hammer-drilling mode, in which the ratchet mechanism is enabled to provide hammer-drilling operation. For example, in the illustrated embodiment, the collar 296 is configured to open a radial clearance for one or more locking balls 301 when in the third position, as shown in FIG. 8. When the radial clearance is open, the drive shaft 264b is able to be displaced rearward along the axis A1, pressing the rotatable ratchet 392 into engagement with the fixed ratchet 388. As such, when the drive shaft 264b is driven to rotate, the teeth 400 slide over the teeth 396 as described above to impart hammering. When the radial clearance is closed (i.e., when the collar 296 is not in the third position), the locking ball(s) 301 is unable to be displaced outwardly, and the locking ball(s) 301 thereby block rearward movement of the drive shaft 264b and prevent the ratchets 392, 388 from coming into contact.

In the illustrated embodiment, the collar 296 is also operable to provide various torque settings via a clutch mechanism 297. In particular, the power tool 210 may enter the clutch mode when the collar 296 is moved to any one of the plurality of clutch positions, which may differ from the first, second, and third positions. For example, when rotating the collar 296 in a single direction, the collar 296 may be moved into each of the first, second, third, and the plurality of clutch positions in series. Each of the clutch positions may correspond with a different torque setting. In some embodiments, the collar 296 may be movable to five or more discrete clutch positions. In some embodiments, the collar 296 may be movable to ten or more discrete clutch positions. In some embodiments, the collar 296 may be movable to fifteen or more discrete clutch positions.

In some embodiments, the speed of the electric motor 230 may vary depending on the setting of the clutch mechanism 297 (and corresponding position of the collar 296). In other embodiments, the speed of the electric motor 230 may correspond to the electronic high speed, the electronic low speed, or another speed when the power tool 210 is in the clutch mode.

In some embodiments, the clutch mechanism 297 may be a mechanical clutch mechanism including, for example, an adjustable compression spring. A pre-load of the compression spring may be adjusted by rotating the collar 296 between the plurality of clutch positions, which may in turn vary a slip torque of the clutch mechanism 297. In other embodiments, the clutch mechanism 297 may be an electronic clutch mechanism configured to receive an electronic torque setting and electronically (e.g., via controller 267 stopping operation of the motor 230) and/or mechanically (e.g., via an adjustable slip condition of the clutch mechanism 297) limit the torque output of the power tool 210 based on the torque setting when the power tool 210 is operated in the clutch mode. The power tool 210 may include one or more sensors (e.g., motor current sensors, torque sensors, or any other suitable sensors) able to detect parameters that can be correlated with a torque output of the power tool 210. The controller 267 is configured to activate the electronic clutch mechanism 297 in response to the detected parameters indicating an output torque that equals or exceeds the selected torque setting, which may be based on the position of the collar 296.

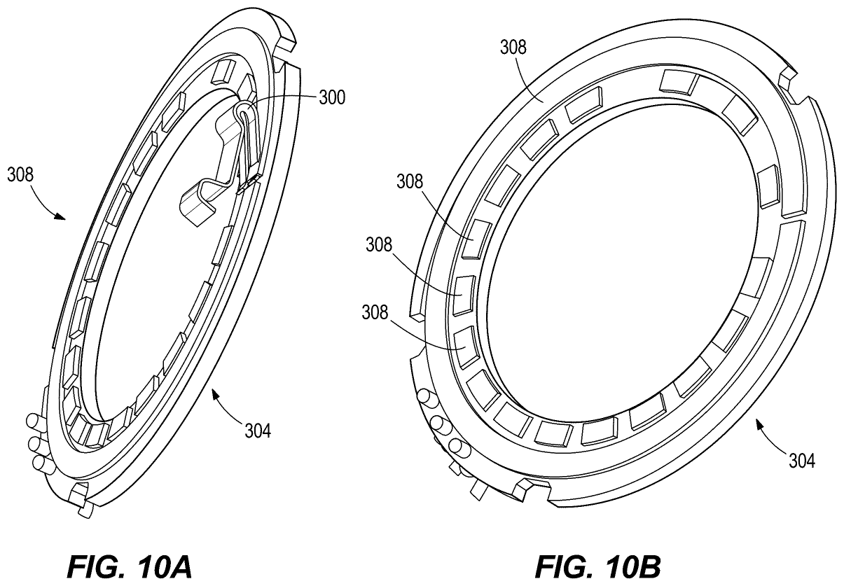

With reference to FIGS. 8, 10A, and 10B, the illustrated collar 296 is coupled to a wiper spring 300 such that the wiper spring 100 is coupled for rotation with the collar 296. A collar printed circuit board 304 is disposed within the front housing portion 226 such that the wiper spring 300 is in contact with the collar printed circuit board 304. When the collar 296 is rotated, the wiper spring 300 is slidable along a plurality of electrical pads 308 provided on the collar printed circuit board 304 to generate an electrical path that provides a variable resistance (e.g., depending which of the electrical pads 308 is aligned with the wiper spring 300) that can be detected by a controller 267. In other embodiments, the collar 296 and the circuit board 304 may include other suitable combinations of features and sensors to detect the position/mode of the collar 296 and provide that feedback to the controller 267.

The speed of the electric motor 230 may be electronically adjusted in a number of different ways. For example, in the hammer-drilling mode, the motor 230 of the power tool 210 may be operated at a speed greater than the electronic high speed of the second speed mode and the electronic low speed of the first speed mode. As such, a speed of the electric motor 230 is adjusted such that the electric motor 230 is provided with an increased speed (i.e., a speed boost) when in the hammer-drilling mode. The speed of the electric motor 230 may be adjusted by field weakening, controlling phase advancement with block commutation, speed clipping, implementing negative id injection using field oriented control technique, etc.

In some embodiments, operation of the collar 296, to electronically control the electric motor 230, may be enabled when a speed selector switch 266 is in a first position corresponding to a low speed mode of the power tool 210 or a second position corresponding to a high speed mode of the power tool 210. In other embodiments, operation of the collar 296, to electronically control the electric motor 230, may be disabled when the speed selector switch 266 is in the first position or the second position. In further embodiments, operation of the collar 296, to electronically control the electric motor 230, may be enabled in the first position and the second position of the speed selector switch 266. In additional embodiments, the collar 296 may provide a first electronic speed setting when the speed selector switch 266 is in the first position and a second electronic speed setting, different than the first electronic speed setting, when the speed selector switch 266 is in the second position.

With reference back to FIG. 7, the power tool 210 includes a plurality of operation buttons 360 provided along a top surface of the battery receptacle 250. A respective operation button 360 may be pressed by the user to adjust functional feature of the power tool 210. For example, one of the operation buttons 360 may be used to actuate an auto-stop function. In another example, another one of the operation buttons 360 may be used to actuate a ONE-KEY® application from Milwaukee Electric Tool Corporation. In other embodiments, the plurality of operation buttons 360 may actuate a desired electronic mode such that the plurality of operation buttons 360 or the collar 296 can be used to select the desired electronic mode.

Thus, the present disclosure provides, among other things, a power tool with a multi-function collar that allows a user to conveniently select between multiple functions of the power tool including, for example, electronic speed modes, a hammer-drilling mode, and/or one or more clutch modes. Although the disclosure has been described in detail with reference to certain preferred embodiments, variations and modifications exist within the scope and spirit of one or more independent aspects of the disclosure as described.

Various features and aspects of the present invention are set forth in the following claims.

What is claimed is:

1. A power tool comprising:
a housing;
a drive mechanism supported within the housing, the drive mechanism having a motor and a transmission configured to receive torque from the motor;
an output drive operably coupled to the drive mechanism to provide torque to a workpiece; and
an electro-mechanical speed select mechanism including
a switch operably coupled to the transmission to adjust an operating gear ratio when moving between a first switch position and second switch position, and
a collar movably coupled to the housing to electronically adjust an operating speed of the motor, the collar movable between a first position corresponding to a first electronic speed setting and a second position corresponding to a second electronic speed setting different than the first electronic speed setting.

2. The power tool of claim 1, wherein the collar is movable to a third position corresponding to a clutch mode.

3. The power tool of claim 1, wherein the collar is movable to a third position corresponding to a hammer-drilling mode.

4. The power tool of claim 1, wherein the transmission includes a movable ring gear coupled to the switch such that movement of the switch to the first switch position provides a first operating mode of the transmission and movement of the switch to the second switch position provides a second operating mode of the transmission.

5. The power tool of claim 4, wherein the movable ring gear is movably coupled to the switch by a wire, and wherein the switch includes at least one support coupled to the wire and extending along a length of the wire.

6. The power tool of claim 4, wherein the first operating mode corresponds with a low speed mode and the second operating mode corresponds with a high speed mode, and wherein the first electronic speed setting is an electronic low speed and the second electronic speed setting is an electronic high speed.

7. The power tool of claim 1, further comprising:
a wiper spring rotatably coupled to the collar; and
a printed circuit board disposed within the housing and having a plurality of electrical pads corresponding to the first position and the second position of the collar,
wherein the wiper spring is slidable along the plurality of electrical pads upon rotation of the collar.

8. The power tool of claim 1, wherein the switch is a first switch, and further comprising a second switch movable for determining a direction of rotation of the motor.

9. The power tool of claim 1, wherein the collar is movable to a third position corresponding to a hammer-drilling mode and to a fourth position corresponding to a clutch mode.

10. A power tool comprising:
a housing;
a drive mechanism supported within the housing, the drive mechanism having a motor and a transmission configured to receive torque from the motor;
an output drive operably coupled to the drive mechanism to provide torque to a workpiece; and
an electro-mechanical speed select mechanism including
a first actuator operably coupled to the transmission and operable to adjust an operating gear ratio of the transmission by moving a ring gear of the transmission, and
a second actuator operable to electronically adjust a maximum operating speed of the motor.

11. The power tool of claim 10, wherein the transmission further includes a first gearset, a second gearset, and a lock ring selectively engageable with the ring gear to adjust the operating gear ratio.

12. The power tool of claim 11, wherein the first actuator moves the ring gear between a first position, in which the ring gear engages the first gearset and the lock ring to adjust the operating gear ratio to a first gear ratio, and a second position, in which the ring gear engages the first gearset and the second gearset to adjust the operating gear ratio to a second gear ratio.

13. The power tool of claim 10, wherein the second actuator is movable between a plurality of positions in which the motor is electronically limited to a respective speed setting.

14. The power tool of claim 10, further comprising a plurality of operation buttons provided on the housing, the plurality of operation buttons configured to actuate an electronic mode at which the motor is controlled.

15. A power tool comprising:
a housing;
a drive mechanism supported within the housing, the drive mechanism having a motor and a transmission configured to receive torque from the motor;
an output drive operably coupled to the drive mechanism to provide torque to a workpiece, the output drive configured to be driven by the motor about a first axis;
a clutch mechanism operably coupled between the drive mechanism and the output drive; and
an electro-mechanical speed select mechanism including
a switch operably coupled to the transmission to adjust an operating gear ratio, and
a collar movably coupled to the housing between a first position corresponding to a first electronic speed setting, a second position corresponding to a second electronic speed setting different than the first electronic speed setting, and a third position corresponding to a clutch mode in which an output torque of the output drive is limited by the clutch mechanism.

16. The power tool of claim 15, wherein the clutch mode includes a plurality of positions of the collar different than the first position and the second position, each position of the plurality of positions corresponding with a different torque setting of the clutch mechanism.

17. The power tool of claim 16, wherein the clutch mechanism is a mechanical clutch mechanism including a spring, and wherein rotation of the collar varies a preload on the spring.

18. The power tool of claim 16, wherein the clutch mechanism is an electronic clutch mechanism configured to limit the output torque of the output drive by deactivating the motor when the output torque reaches or exceeds a selected torque setting of the clutch mechanism.

19. The power tool of claim 15, further comprising a sensor configured to detect a position of the switch.

20. The power tool of claim 15, further comprising a sensor configured to detect a position of the collar.
